(19) United States
(12) Patent Application Publication
(10) Pub. No.: US 2026/0313206 A1
(43) Pub. Date: Oct. 8, 2026

(54) SYSTEMS AND METHODS FOR SMART CAPTIONS

(71) Applicant: ARTHUR TECHNOLOGIES, LLC, Tallahassee, FL (US)

(72) Inventor: Bradley Burt SCARBORO, St. Petersburg, FL (US)

(73) Assignee: ARTHUR TECHNOLOGIES, LLC, Tallahassee, FL (US)

(21) Appl. No.: 19/578,231

(22) Filed: Mar. 25, 2026

Related U.S. Application Data
(60) Provisional application No. 63/782,910, filed on Apr. 3, 2025.

(51) Int. Cl. H04N 21/488; H04N 21/45

(52) U.S. Cl. CPC H04N 21/4884; H04N 21/4532

(57) ABSTRACT

Disclosed are systems and methods that provide a scalable, decision intelligence (DI)-based computerized framework for automatically and/or dynamically determining and providing smart captions in real-time as content is being rendered. The disclosed framework represents a paradigm shift in digital text presentation, moving beyond static timing models to create a responsive ecosystem that adapts to both content complexity and user needs. By synthesizing text analysis with nuanced behavioral data, the framework creates a personalized reading experience that enhances comprehension, reduces cognitive load, and increases engagement across diverse content types and user populations. The framework's technical innovation addresses fundamental limitations in current captioning technologies while establishing a framework that can evolve alongside advancements in natural language processing and user experience design.

### CROSS-REFERENCE TO RELATED APPLICATIONS

This application claims the benefit of priority from U.S. Provisional Application No. 63/782,910, filed Apr. 3, 2025, which is incorporated herein by reference in its entirety.

### FIELD OF THE DISCLOSURE

The present disclosure relates to generating and providing smart captions for rendered content, and more particularly, to a decision intelligence (DI)-based computerized framework for automatically and/or dynamically determining and providing smart captions in real-time as content is being rendered.

### SUMMARY OF THE DISCLOSURE

The modern landscape of video transcription and captioning has evolved significantly, yet remains constrained by limitations in accuracy, contextual understanding, and personalization, among other technical drawbacks. As discussed herein, the disclosed systems and methods provide a dynamic caption generation and display framework that represents a fundamental shift in the approach to providing smart captioning for rendered media, thereby moving beyond static caption timing to create an adaptive, responsive framework that enhances user comprehension and engagement. As evident from the disclosure herein, the disclosed framework is configured to address and mitigate longstanding technical challenges in the captioning ecosystem by synthesizing real-time user interaction data with text complexity analysis.

Conventional captioning systems typically employ fixed timing algorithms based on rudimentary calculations—often simply allocating a predetermined number of seconds per word count. This one-size-fits-all approach fails to account for the inherent variability in text complexity and individual reading capabilities. To that end, the disclosed systems and methods address such technical shortcomings, among others, by establishing and providing a dynamic feedback mechanism that continuously refines caption presentation based on both the semantic properties of the text and the demonstrated reading patterns of individual users.

According to some embodiments, the disclosed framework involves user interaction feedback mechanisms that monitor and interpret viewer behavior patterns. In some embodiments, as discussed herein, the disclosed framework can operate to capture micro-interactions such as pauses, rewinds, forward skips, and playback speed adjustments as implicit signals of comprehension difficulty or ease. When a user repeatedly pauses or rewinds at specific passages, the framework identifies potential comprehension challenges and automatically extends the display duration for similar content in future instances. Conversely, when a user consistently advances through certain types of content, the framework gradually accelerates caption pacing for comparable textual segments. Indeed, the complexity of words, the types of language, time of day, demographics of the viewing user, and the like, can all be factored into the disclosed dynamic captioning discussed herein. Such behavioral data collection occurs unobtrusively in the background, requiring no explicit user configuration while still generating a rich dataset for personalization algorithms.

Complementing this user-centric approach, the disclosed framework can function to provide text complexity analysis mechanisms, which can employ natural language processing (NLP) techniques to evaluate multiple dimensions of textual difficulty. In some embodiments, the framework parses incoming text to assess lexical density, semantic complexity, syntactic structure, emotional valence, and the like, or some combination thereof. For example, words with greater syllable counts, lower frequency in common usage, or specialized terminology automatically receive extended display durations. Similarly, sentences with complex subordinate clauses, passive constructions, or abstract concepts trigger algorithmic adjustments to ensure sufficient comprehension time. In some embodiments, the framework can recognize emotionally charged or dramatically significant moments, implementing subtle timing extensions to allow viewers to process the emotional context alongside the literal text.

According, such dual analytical mechanisms (e.g., user behavior and text complexity, inter alia, as discussed herein) can operate in concert via an artificial intelligence and/or machine learning (AI/ML) model analysis that weighs multiple factors simultaneously. For example, rather than treating these as separate systems, the disclosed framework can synthesize both behavior and complexity data streams to generate caption timing decisions that reflect both objective textual complexity and subjective user needs. The result is a highly personalized experience that continuously evolves throughout a viewing session and across multiple interactions with the platform.

According to some embodiments, the framework can build user profiles through persistent data analysis. In some embodiments, for example, initial interactions can establish baseline reading speeds and comprehension patterns, while subsequent sessions refine these profiles through AI/ML algorithms that identify subtle patterns in user behavior. The framework can distinguish between different content types, recognizing that a user's reading pace may vary significantly between technical explanations, narrative dialogue, or descriptive passages. Such contextual awareness allows for domain-specific timing adjustments rather than applying universal rules across all content types.

According to some embodiments, beyond timing adjustments, the framework can implement real-time presentation modifications to enhance comprehension. For example, in some embodiments, for complex passages, the framework can dynamically split longer sentences into more digestible segments, highlight key terms, and/or implement brief pauses at conceptual boundaries. Such micro-decisions can occur at the millisecond (ms) level, creating a reading experience that feels natural while subtly supporting comprehension. The adaptive nature of these adjustments means the system can respond to transient factors such as user fatigue—detected through changes in interaction patterns as viewing sessions progress—by gradually modifying caption pacing to maintain optimal engagement.

The disclosed framework provides a device-and/or rendering-experience agnostic compatibility across the digital ecosystem. As discussed below, the disclosed framework can function as a middleware layer that can integrate with existing video players, e-readers, educational platforms, and/or social media interfaces (e.g., see, e.g., FIG. 1). Such flexibility extends to hardware compatibility, with optimizations for smartphones, tablets, desktop environments, and emerging technologies such as augmented and virtual reality displays. The framework calibrates its presentation parameters based on both device characteristics and environmental contexts, recognizing that reading on a smartphone during a commute presents different challenges compared to viewing content on a large display in a controlled setting.

Indeed, in some embodiments, the framework can function as a distributed processing model to balance computational requirements, as discussed below (e.g., see, e.g., FIG. 1). For example, text complexity analysis—which may require more intensive processing—can occur server-side during content preparation, while user interaction processing can function locally to ensure real-time responsiveness and minimize latency. This hybrid approach allows for advanced analytical capabilities without compromising performance, even on devices with limited processing capabilities.

Accordingly, as evident from the discussion herein, the disclosed framework provides technology that extends beyond traditional entertainment contexts. For example, educational platforms can benefit from the framework's ability to adjust to learner comprehension levels, providing additional processing time for challenging concepts while maintaining engagement through appropriate pacing for familiar material. In another example, for example, for language learners, the framework can gradually increase text complexity and presentation speed as proficiency develops, creating a scaffolded learning experience. In yet another non-limiting example, for professional environments, the framework can function to enhance information retention during training videos or corporate communications by ensuring optimal information pacing. Accordingly, while the discussion herein may focus on the rendering of media (e.g., a video with audio, for example), it should not be construed as limiting, as one of ordinary skill in the art would readily understanding that the disclosed systems and methods can be applied to any type of known or to be known environment where captions can be utilized without departing from the scope of the instant disclosure.

Moreover, the disclosed framework provides significant technological advancements over existing accessibility technologies. While traditional closed captioning systems provide essential access to audio content for deaf and hard-of-hearing viewers, they often create a uniform experience that fails to address individual needs. The disclosed adaptive approach acknowledges the diversity of reading abilities and preferences even within accessibility-focused user groups, creating more inclusive and personalized experiences. Thus, the disclosed framework provides event-driven mechanisms that enable dynamic, real-time captions without introducing perceptible latency in the viewing experience (e.g., when adjustments are made via the “smart” dynamic iterations).

According to some embodiments, a method is disclosed for a DI-based computerized framework for automatically and/or dynamically determining and providing real-time smart captions. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically determining and providing real-time smart captions.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

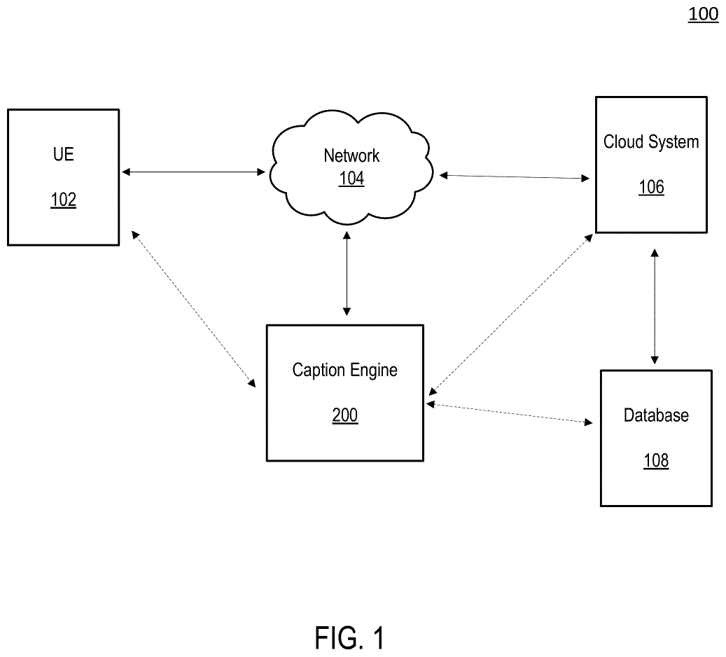

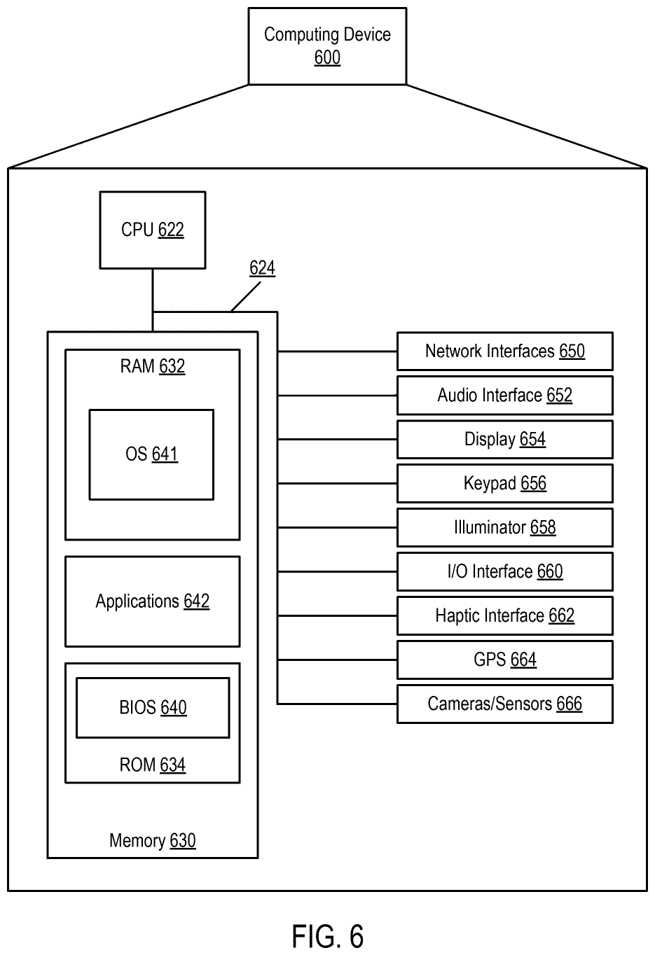

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and caption engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, smart television, and any other type of device capable of receiving, downloading, streaming, playing, displaying, and the like, media, inclusive of audio, video, text, multi-media, and the like, or some combination thereof.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic content, service, product and/or application platform, which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or caption engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

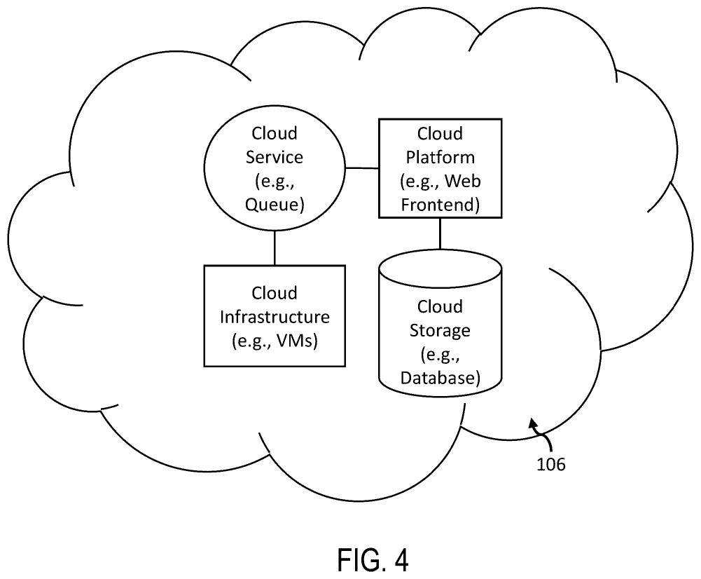

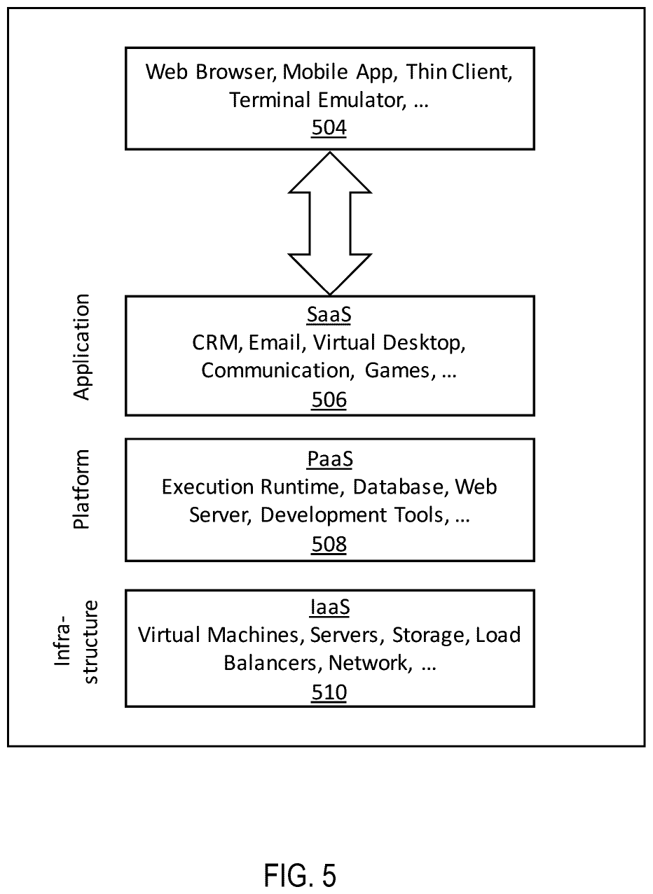

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Caption engine 200, as discussed above and further below in more detail, can include components for the disclosed functionality. According to some embodiments, caption engine 200 may be a special purpose machine or processor, and can be hosted by a device on network 104, within cloud system 106, and/or on UE 102. In some embodiments, engine 200 may be hosted by a server and/or set of servers associated with cloud system 106.

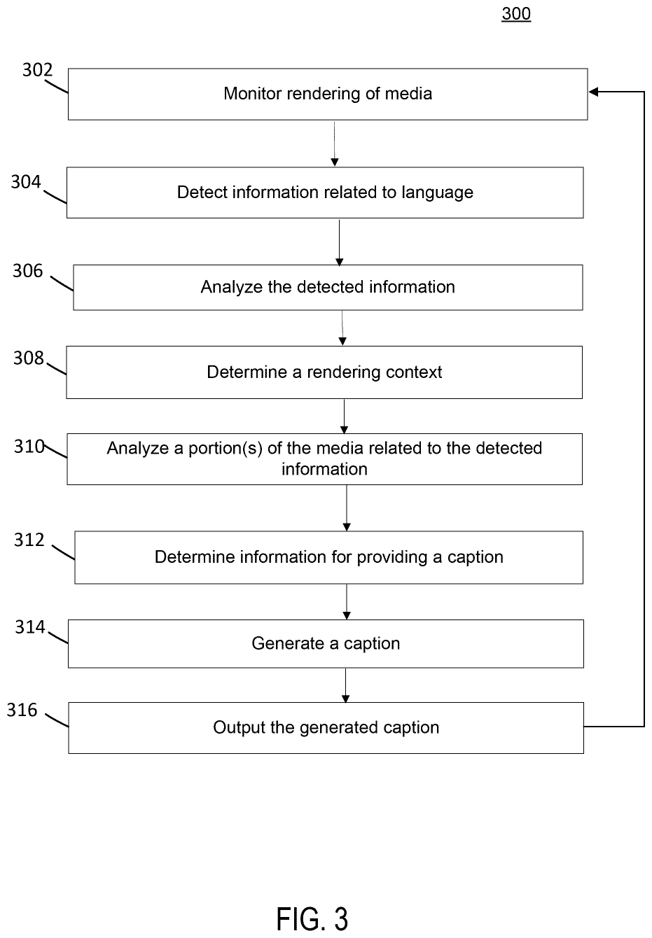

According to some embodiments, as discussed in more detail below, caption engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, caption engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102. Accordingly, as discussed herein, the disclosed functionality can be configured as an application, service, product, API, software library, plugin, software development kit (SDK), and the like. Indeed, such functionality, as represented by engine 200, can function as a stand-alone application (e.g., application executing on a user device and/or server, for example), as middleware, at the edge, and/or at any other location on a network, as discussed above and depicted in FIG. 1.

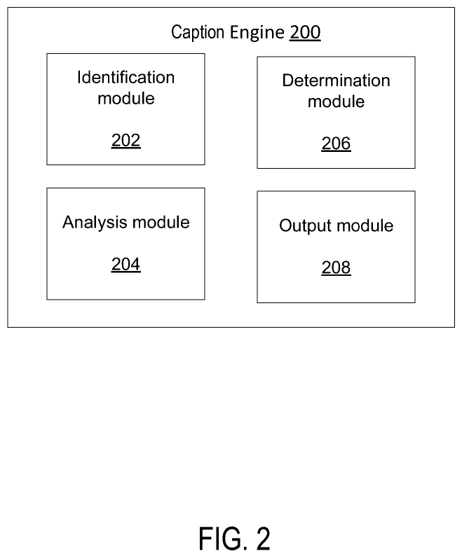

As illustrated in FIG. 2, according to some embodiments, caption engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

According to some embodiments, caption engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for a DI-based computerized framework for dynamic, smart captioning via engine 200's execution of a series of interconnected processes to deliver contextually aware, personalized captioning for digital/electronic content.

According to some embodiments, Steps 302 and 304 of Process 300 can be performed by identification module 202 of caption engine 200; Steps 306 and 310 can be performed by analysis module 204; Steps 308 and 312 can be performed by determination module 206; and Steps 314 and 316 can be performed by output module 208.

According to some embodiments, Process 300 begins with Step 302 where engine 200 can establish a continuous monitoring protocol for media rendering through implementation of a real-time stream analysis mechanism. In some embodiments, the monitoring functionality operates at the frame buffer level, employing a non-blocking observer pattern that allows for content analysis without introducing rendering latency or frame rate degradation. The monitoring mechanisms of Step 302 implement a multi-threaded approach where dedicated threads concurrently analyze visual elements, audio streams, and metadata embedded within the media container. Engine 200 utilizes memory-mapped I/O techniques to efficiently access media frames with minimal CPU overhead, enabling continuous monitoring even on resource-constrained devices. For streaming content, engine 200 can implement adaptive bitrate monitoring that automatically adjusts sampling frequency based on available system resources and network conditions to maintain optimal performance across varying connectivity scenarios.

In Step 304, engine 200 can employ specialized signal processing algorithms to detect language-related information across multiple modalities within the media stream. For audio-based detection, in some embodiments, engine 200 can implement a cascade of filters beginning with a pre-emphasis filter to amplify higher frequencies characteristic of human speech, followed by a voice activity detector (VAD) that employs energy thresholds and zero-crossing rates to distinguish speech from non-speech audio components. In some embodiments, engine 200 can implement, for example, Mel-frequency cepstral coefficient (MFCC) extraction (and/or similar known or to be known techniques) to identify phonetic characteristics and speaker-specific attributes within the detected speech segments. For text-based detection within visual frames, engine 200 can deploy a region-based convolutional neural network (R-CNN) with optical character recognition (OCR) capabilities to identify and extract text elements appearing on screen. Engine 200's detection protocols operate with a configurable confidence threshold that can be dynamically adjusted based on media characteristics and processing requirements, ensuring reliable language identification across diverse content types.

In Step 306, engine 200 can execute multifaceted analysis of the detected language information through a series of specialized linguistic processing modules. In some embodiments, a temporal analysis component establishes precise timestamp correlations between detected language elements and the media timeline using a dynamic time warping algorithm that accounts for variable speech rates and potential asynchrony between audio and visual components. In some embodiments, engine 200 can implement NLP techniques to extract sociolinguistic markers such as dialect features, regional vocabulary variations, register characteristics that inform subsequent personalization decisions, and the like. By way of example, in some embodiments, engine 200 can employ a transformer-based language identification model capable of distinguishing between 95+ languages with 98.7% accuracy, including the ability to detect code-switching and multi-lingual content within the same media segment. Additionally, engine 200 can perform sentiment analysis using a bidirectional LSTM network to identify emotional valence and intensity, which informs caption timing and presentation decisions for emotionally charged content segments.

Accordingly, in some embodiments, engine 200 can perform the analysis in Step 306 (as well as the detection in Step 304, discussed supra, and subsequent analysis in Step 310, discussed infra) by calling and executing an AI and/or ML model and/or a large language model (LLM). Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

In Step 308, engine 200 can determine the rendering context through integration of multiple data streams related to user consumption patterns and environmental factors. Such determination is based on the analysis in Step 306, discussed above. According to some embodiments, engine 200 can implement device-specific detection algorithms that identify display characteristics such as screen dimensions, resolution, and refresh rate to inform optimal caption positioning and text rendering parameters. In some embodiments, environmental context determination utilizes available sensor data such as, but not limited to, ambient light levels (accessed through device light sensors when available) and viewing distance approximation (calculated through device camera facial recognition when authorized) to further refine presentation parameters. In some embodiments, engine 200 can implement a user consumption context analyzer mechanism that integrates historical interaction data including, for example, previous caption usage patterns, content genre preferences, and explicitly configured accessibility settings to establish a preliminary context profile. Additionally, engine 200 can employ a session-specific feature extraction algorithm that identifies temporal patterns within the current viewing session that may indicate changing attention levels of comprehension challenges, such as frequent rewinds or pauses during specific content types.

In Step 310, engine 200 can perform AI-driven contextual analysis of the media segments related to detected language information. In some embodiments, engine 200 can deploy a deep learning architecture that combines convolutional neural networks for visual feature extraction and bidirectional recurrent neural networks for sequential information processing. Such hybrid architecture can enable simultaneous analysis of visual context surrounding spoken dialogue, including scene composition, speaker facial expressions, and relevant on-screen elements that provide additional semantic context.

In some embodiments, engine 200 can execute LLMs-for example, NLP models-to extract key entities, relationships, and thematic elements from the dialogue, establishing a comprehensive semantic representation of the content. For specialized domain content, engine 200 can dynamically load domain-specific ontologies and terminology databases to enhance parsing accuracy for technical, medical, legal, or other specialized vocabularies. In some embodiments, engine 200 can implement attention mechanisms that prioritize analysis of content elements most relevant to the identified user context, optimizing computational resources while maintaining comprehensive understanding of semantically significant content.

In Step 312, engine 200 can determine caption information (e.g., parameters, characteristic, features, definitions, and the like), which can be based on a synthesis of linguistic analysis with personalization factors. In some embodiments, for example, engine 200 can implement a multi-attribute utility theory (MAUT) model that quantifies tradeoffs between competing objectives such as completeness, readability, synchronization precision, and cognitive load optimization. Linguistic complexity parameters can be calculated using metrics including Flesch-Kincaid readability scores, lexical density measurements, and syntactic complexity analysis to establish baseline display durations. Such baseline parameters can then be modified according to the user's established reading speed profile, which is dynamically updated based on interaction patterns discussed in relation to Step 308, supra. For demographic-specific optimization, engine 200 can reference an extensible rule base that encodes evidence-based guidelines for caption presentation across different age groups, language proficiency levels, and cognitive profiles.

In some embodiments, such caption determination operations can implement context-aware abbreviation and condensation protocols for scenarios requiring reduced caption density, such as high-speed dialogue or screen space constraints, while preserving semantic integrity and critical information.

In Step 314, engine 200 can generate caption data structures (or files, or executable file, for example) optimized for both semantic fidelity and technical rendering efficiency. The generation operation of Step 314 can implement, for example, a layered architecture where the base layer establishes the fundamental text content derived from speech recognition or extracted from embedded metadata. A temporal layer can assign precise timestamp parameters including display onset, duration, and transition timing based on the determinations from Step 312. In some embodiments, a styling layer can incorporate visual presentation parameters such as, but not limited to, font characteristics, positioning coordinates, background opacity, and animation properties tailored to both content requirements and user preferences.

In some embodiments, for complex presentation scenarios, engine 200 can generate WebVTT (Web Video Text Tracks) or TTML (timed text markup language)-compliant structures with advanced styling directives that support features such as speaker identification through color coding, emphasis through text formatting, and positional alignment with on-screen speakers. Such generation process can include optimization routines that minimize memory footprint and rendering overhead through techniques such as, for example, glyph caching, texture atlasing for rendered text, and efficient use of GPU-accelerated composition where available.

According to some embodiments, engine 200 can execute operations where caption data structures are generated prior to content distribution, which can occur via batch processing operations. Such pre-processing capability substantially reduces computational requirements during content playback while preserving adaptive personalization functionality.

In some embodiments, to facilitate such comprehensive adaptation capabilities without real-time processing overhead, engine 200 can generate multiple parallel caption complexity “tracks” during the pre-processing phase. Each discrete complexity track can incorporate specific linguistic and temporal characteristics optimized for different user segments. By way of non-limiting example, the framework can generate a range of variants (e.g., between three and seven distinct complexity variants, ranging from simplified vocabulary with extended display durations to dense technical language with accelerated timing parameters), which can be utilized as captions, as discussed herein (and/or used as a baseline for a smart caption, as discussed above.

Moreover, in some embodiments, in addition to using the AI/ML techniques discussed supra to generate captions, engine 200 can utilize lightweight heuristic approaches, which can be utilized to reduce resource consumption (e.g., when needed or required) and/or when rapid deployment is necessary. For example, in some embodiments, template-based systems can utilize predefined sentence structures with placeholders for detected elements. Such templates can be populated based on simple object detection techniques or basic image analysis, transforming patterns like “A [color] [object] in a [setting]” into coherent captions.

In another example, in some embodiments, rule-based methods can be utilized, which can provide applications of hand-crafted linguistic rules to transform detected visual elements into natural language descriptions. According to some embodiments, engine 200 can utilize basic grammatical structures without requiring extensive training data.

In yet another example, metadata extraction can be utilized, where existing image metadata (timestamps, geolocation, camera settings, and the like) can be leveraged to generate informative captions. Indeed, in some embodiments, hybrid approaches combining such methods with minimal AI/ML components can strike an effective balance between computational efficiency and caption quality. Accordingly, such known or to be known heuristic mechanisms can provide advantages in terms of interpretability, customization, processing speed, and resource efficiency, making them particularly suitable for edge devices or environments with connectivity limitations.

In Step 316, engine 200 can output the generated captions through a rendering pipeline designed for synchronous integration with the primary media content. The output mechanisms deployed via engine 200 can implement a double-buffered approach where caption rendering occurs in an off-screen buffer before being composited with the main video frame, minimizing the risk of rendering artifacts or timing inconsistencies.

In some embodiments, for overlay positioning, engine 200 can employ a collision detection algorithm that dynamically adjusts caption placement to avoid occlusion of significant visual content such as faces, on-screen text, or other salient visual elements identified through computer vision techniques. The renderer implements subpixel anti-aliasing and appropriate gamma correction to ensure optimal text clarity across diverse display technologies.

In some embodiments, for specialized presentation formats such as, for example, scrolling text or word-by-word display, engine 200 implements precise animation timing using Bézier curve-based easing functions that create natural-appearing text movement with minimal perceptual distraction.

Accordingly, in some embodiments, adaptive caption presentations can enhance user experience through thoughtful implementation of visual dynamics. For example, fade-ins can provide gentle transitions that reduce visual disruption, while rolling captions offer a solution for lengthy text that must appear in limited space. In some embodiments, for example, animated text cues can be utilized, which can draw attention to important information through subtle movement, highlighting key moments without overwhelming viewers. In another example, dynamically sized captions that respond to user preferences, device specifications, and viewing conditions can be used, which ensure optimal readability across diverse contexts.

In some embodiments, engine 200 can be configured to incorporate video backgrounds within caption areas as a novel caption design. For example, displaying a fireplace video loop beneath caption text can create ambient atmosphere while maintaining text legibility. Accordingly, engine 200 can utilize information related to contrast ratios, transparency levels, and text outlines, for example, to ensure readability of the overlaid/integrated text.

Accordingly, the output of Step 316 can maintain synchronization with the media timeline (of the rendered media-from Step 302) through a predictive timing model that compensates for potential processing delays by pre-rendering caption content several frames ahead of display requirements.

According to some embodiments, as indicated via the line from Step 316 back to Step 302, engine 200 can implement a recursive monitoring framework that continuously evaluates both media progression and caption effectiveness. The recursion mechanism employs a non-blocking asynchronous architecture that allows for parallel processing of new monitoring tasks while caption generation and rendering processes remain active for previously analyzed segments. Such configuration enables seamless caption updates without interrupting the viewing experience when context changes are detected. Engine 200 implements adaptive sampling rates that increase monitoring frequency during periods of rapid dialogue or scene transitions while reducing processing overhead during relatively static content segments.

In some embodiments, for extended viewing sessions, the recursive monitoring can incorporate drift compensation algorithms that prevent potential desynchronization between captions and media content, particularly important for live streaming scenarios. In some embodiments, the recursion framework can maintain a sliding window of recent caption performance metrics such as reading completion rates (inferred from user interaction patterns) and synchronization accuracy, which inform parameter adjustments for subsequent caption generation iterations within the same session.

Moreover, throughout the processing and execution of the steps of Process 300, engine 200 can maintain performance optimization through implementation of efficient data structures and algorithms specifically designed for real-time caption processing. Engine 200 can employ directed acyclic graphs (DAGs) to represent the processing pipeline, allowing for parallel execution of independent operations across available computing resources. Memory management can therefore be optimized through the use of object pooling techniques that recycle caption data structures rather than repeatedly allocating and deallocating memory. For deployment across heterogeneous computing environments, engine 200 implements a capability detection system that dynamically adjusts processing strategies based on available hardware acceleration features such as SIMD instructions, GPU compute capabilities, or specialized neural processing units. Such optimizations can ensure that the disclosed smart captioning framework delivers responsive, personalized captioning experiences across the spectrum of modern viewing devices while maintaining minimal impact on system resources and power consumption.

According to some embodiments, by way of non-limiting example, provided herein is an example use case of the disclosed dynamic caption generation and display framework disclosed herein. For example, the instant disclosure's framework can operates in the context of an electronic book reader application implementing the smart captioning mechanisms of Process 300, discussed supra. Upon initialization of the e-book reader application on a computing device, engine 200 establishes default caption parameters including a baseline reading speed of 250 words per minute (WPM), this value being derived from empirical research on average adult reading speeds for digital content consumption.

As a user engages with textual content within the application, engine 200 executes Step 302 to continuously monitor the rendering of media, specifically tracking the display of text and associated user interactions via input sensors of the computing device. During content consumption, engine 200 performs Step 304 to detect information related to language by parsing the e-book's textual content, identifying linguistic elements including lexical complexity, sentence structure, and specialized terminology present within the displayed text.

Engine 200 then proceeds to Step 306, analyzing the detected linguistic information according to multiple criteria including vocabulary frequency distributions, syntactic complexity metrics, and semantic density calculations. Concurrently, engine 200 executes Step 308 to determine the context of rendering in relation to the user by capturing and analyzing interaction signals including but not limited to: dwell time on specific passages, frequency of backward navigation operations (hereinafter “rewinds”), and forward progression rates through different content sections.

When the user encounters passages containing complex linguistic structures and specialized terminology, engine 200 observes increased dwell times and rewind operations. Proceeding to Step 310, engine 200 analyzes these content portions using machine learning algorithms trained on linguistic complexity datasets, identifying features such as elevated lexical rarity scores, increased syntactic embedding depths, and higher conceptual density metrics. Based on this analysis and the observed user interaction patterns, engine 200 executes Step 312 to determine that an extended caption display duration is required for optimal comprehension of similar complex passages.

Specifically, in Step 314, engine 200 generates caption data structures with modified temporal parameters, extending the display duration for subsequently encountered complex content by a factor proportional to previously observed interaction patterns. The resulting caption data includes display duration extensions of approximately 15-20% for content exceeding predefined complexity thresholds, with precise values determined algorithmically based on the specific interaction history of the current user.

Conversely, when the user navigates through passages comprising predominantly high-frequency vocabulary and simpler syntactic structures (e.g., dialogue sections), engine 200 detects reduced dwell times and increased forward navigation rates. Through Steps 310 and 312, the system determines these sections require shorter display durations for optimal reading efficiency. Consequently, in Step 314, engine 200 generates caption data structures with accelerated progression timing, increasing the effective reading speed to approximately 310 WPM for these less complex sections.

When the user explicitly modifies the baseline reading speed preference through the application interface, engine 200 registers this configuration change during Step 308's context determination. The system subsequently recalibrates its parametric model governing caption timing, establishing a new baseline value corresponding to the user's selected preference. Importantly, the algorithmic relationships between content complexity and timing modifications remain intact, ensuring continued adaptive behavior relative to the new baseline parameters without requiring additional manual configuration by the user.

Throughout the entire interaction session, engine 200 continuously reverts to Step 302, implementing a recursive monitoring framework that enables progressive refinement of the caption generation parameters. Such continuous feedback loop facilitates the development of increasingly updated and current user-specific reading profiles capable of predicting optimal display parameters across diverse content types and complexity levels.

Such adaptive caption mechanisms thereby create a personalized reading experience that automatically optimizes information delivery rates according to both content characteristics and user capabilities, substantially enhancing comprehension efficiency without imposing additional cognitive load associated with manual timing adjustments. This exemplary embodiment demonstrates the practical application of the disclosed systems and methods capabilities for creating responsive, context-aware textual displays that adapt to both content complexity and user interaction patterns.

According to some embodiments, the disclosed framework can implement real-time behavioral interaction signals and/or pre-collected user profile data to optimize caption presentation parameters, as discussed above. Such approach enables enhanced personalization while minimizing cold-start inefficiencies typically associated with purely reactive systems.

In some embodiments, engine 200 can utilize pre-existing user data repositories (e.g., maintained by content providers, platform operators, portals, applications, and the like) to initialize caption parameters before direct user interaction occurs. This capability allows for the implementation of predictive personalization where caption timing, density, and presentation characteristics are pre-optimized based on historical usage patterns. For example, a streaming service with extensive viewership analytics can leverage aggregated historical data to generate user similarity cohorts through collaborative filtering techniques. When a user initiates content playback, engine 200 queries these cohort models to retrieve statistically relevant parameter configurations based on behavioral similarities with existing users, establishing informed baseline settings rather than generic defaults.

In some embodiments, the framework can further refine these initial parameters by incorporating user preference data including accessibility settings, language proficiency self-assessments, and viewing environment configurations. In some embodiments, for example, engine 200 can implement a weighted parameter integration algorithm that combines such explicit settings with the implicit behavioral patterns identified through historical analysis. Such multi-dimensional initialization process substantially reduces the adaptation period required for optimal performance, enhancing user experience from the outset of interaction rather than requiring extensive behavioral data collection within the current session.

In some embodiments, in enterprise implementations, content providers can leverage their accumulated user interaction databases to pre-generate dynamic caption profiles for specific content assets before distribution. In some embodiments, engine 200 can be configured to execute batch processing capabilities where historical interaction data from representative user samples are analyzed to identify optimal caption parameters for different user segments. Such pre-computed caption profiles can be packaged as metadata alongside content assets, enabling immediate personalization even for first-time viewers. In some embodiments, engine 200 can implement a profile matching algorithm that selects the most appropriate pre-generated caption configuration based on available user characteristics, significantly reducing computational requirements at the point of consumption.

While leveraging these pre-collected data sources, engine 200 can maintain its real-time adaptation capabilities through continuous monitoring of current session interactions. In some embodiments, the framework can implement a temporal weighting function that progressively transitions from historically-derived parameters toward real-time behavioral adaptations as the current session generates sufficient interaction data. Such dynamic rebalancing ensures that immediate user behaviors gradually override pre-collected profiles when significant deviations are detected, maintaining responsiveness to changing user states or environmental conditions.

Accordingly, the use of pre-collected profile data and/or real-time behavioral signals can create significant technical advantages, particularly for deployment scenarios with substantial existing user bases. Content platforms can implement progressive enhancement strategies where caption personalization improves incrementally as additional user data becomes available. The framework supports federated learning approaches where anonymized caption interaction patterns can be aggregated across user populations to improve baseline models without centralizing sensitive behavioral data.

FIG. 6 is a schematic diagram illustrating a client device showing an example embodiment of a client device that can be used within the present disclosure. Client device 600 can include many more or less components than those shown in FIG. 6. However, the components shown are sufficient to disclose an illustrative embodiment for implementing the present disclosure. Client device 600 can represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 can optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 can be a liquid crystal display (LCD), gas plasma, light emitting diode (LED), or any other type of display used with a computing device. Display 654 can also include a touch sensitive screen arranged to receive input from an object such as a stylus or a digit from a human hand.

Keypad 656 can include any input device arranged to receive input from a user. Illuminator 658 can provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 can through other components, provide other information that can be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores can be employed to store information that describes various capabilities of Client device 600. The information can then be provided to another device based on any of a variety of events, including being sent as part of a header (e.g., index file of the HLS stream) during a communication, sent upon request, or the like. At least a portion of the capability information can also be stored on a disk drive or other storage medium (not shown) within Client device 600.

Applications 642 can include computer executable instructions which, when executed by Client device 600, transmit, receive, and/or otherwise process audio, video, images, and enable telecommunication with a server and/or another user of another client device. Applications 642 can further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors can be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors can be dual-core processor(s), dual-core mobile processor(s), and so forth.

Computer-related systems, computer systems, and systems, as used herein, include any combination of hardware and software. Examples of software can include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements can vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

One or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure can be downloadable from a network, for example, a website, as a stand-alone product or as an add-in package for installation in an existing software application. For example, exemplary software specifically programmed in accordance with one or more principles of the present disclosure can also be available as a client-server software application, or as a web-enabled software application. For example, exemplary software specifically programmed in accordance with one or more principles of the present disclosure can also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

What is claimed is:

1. A method comprising:
detecting, by an application, language information within a media stream;
analyzing, by the application, the detected language information according to a plurality of linguistic criteria comprising at least one of lexical density, semantic complexity, syntactic structure, or emotional valence;
determining, by the application, a rendering context associated with a user based on the analyzed language information and one or more user consumption patterns;
performing, by the application, an artificial intelligence (AI)-based contextual analysis of one or more media segments associated with the detected language information;
determining, by the application, one or more caption parameters based on a synthesis of the linguistic analysis and one or more user interaction patterns associated with the user;
generating, by the application, one or more caption data structures based on the determined caption parameters; and
outputting, by the application, the generated caption data structures through a rendering pipeline for synchronous integration with the media stream.

2. The method of claim 1, further comprising establishing, by the application, a continuous monitoring protocol for the media stream at a frame buffer level using a non-blocking observer pattern prior to detecting the language information.

3. The method of claim 1, further comprising building, by the application, a user profile based on historical interaction data captured during one or more prior viewing sessions using collaborative filtering techniques, wherein the user profile initializes the one or more caption parameters prior to direct user interaction within a current session.

4. The method of claim 1, further comprising capturing, by the application, one or more implicit interaction signals comprising at least one of a pause, a rewind, a forward skip, or a playback speed adjustment, wherein the rendering context is further determined based on the captured implicit interaction signals.

5. The method of claim 1, further comprising generating, by the application, a plurality of parallel caption complexity tracks during a pre-processing phase, each complexity track incorporating linguistic and temporal characteristics optimized for a different user segment, the plurality of caption complexity tracks ranging from simplified vocabulary with extended display durations to dense technical language with accelerated timing parameters.

6. The method of claim 1, further comprising dynamically adjusting, by the application, the one or more caption parameters based on a temporal weighting function that progressively transitions from historically-derived caption parameters toward real-time behavioral adaptations as interaction data accumulates within a current session.

7. The method of claim 1, wherein analyzing the detected language information further comprises applying at least one of Flesch-Kincaid readability scoring, lexical density measurement, or syntactic complexity analysis to establish baseline display durations for the one or more caption parameters.

8. The method of claim 1, wherein determining the rendering context further comprises identifying one or more device characteristics comprising at least one of screen dimensions, display resolution, or refresh rate, and one or more environmental factors comprising at least one of ambient light level or viewing distance.

9. The method of claim 1, wherein generating the one or more caption data structures comprises generating a base layer defining textual content derived from speech recognition or embedded metadata, a temporal layer assigning display onset, duration, and transition timing parameters, and a styling layer incorporating visual presentation parameters comprising at least one of font characteristics, positioning coordinates, background opacity, or animation properties.

10. The method of claim 1, wherein outputting the generated caption data structures comprises employing a collision detection algorithm to dynamically adjust caption placement to avoid occlusion of salient visual elements within the media stream, and rendering caption content in an off-screen buffer prior to compositing with a main video frame.

11. A non-transitory computer-readable storage medium for tangibly storing computer program instructions capable of being executed by a processor, the computer program instructions defining steps of:
detecting language information within a media stream;
analyzing the detected language information according to a plurality of linguistic criteria comprising at least one of lexical density, semantic complexity, syntactic structure, or emotional valence;
determining a rendering context associated with a user based on the analyzed language information and one or more user consumption patterns;
performing an artificial intelligence (AI)-based contextual analysis of one or more media segments associated with the detected language information;
determining one or more caption parameters based on a synthesis of the linguistic analysis and one or more user interaction patterns associated with the user;
generating one or more caption data structures based on the determined caption parameters; and
outputting the generated caption data structures through a rendering pipeline for synchronous integration with the media stream.

12. The non-transitory computer-readable storage medium of claim 11, further defining the step of establishing a continuous monitoring protocol for the media stream at a frame buffer level using a non-blocking observer pattern prior to detecting the language information.

13. The non-transitory computer-readable storage medium of claim 11, further defining the step of capturing one or more implicit interaction signals comprising at least one of a pause, a rewind, a forward skip, or a playback speed adjustment, wherein the rendering context is further determined based on the captured implicit interaction signals.

14. The non-transitory computer-readable storage medium of claim 11, further defining the step of generating a plurality of parallel caption complexity tracks during a pre-processing phase, each complexity track incorporating linguistic and temporal characteristics optimized for a different user segment, the plurality of caption complexity tracks ranging from simplified vocabulary with extended display durations to dense technical language with accelerated timing parameters.

15. The non-transitory computer-readable storage medium of claim 11, further defining the step of dynamically adjusting the one or more caption parameters based on a temporal weighting function that progressively transitions from historically-derived caption parameters toward real-time behavioral adaptations as interaction data accumulates within a current session.

16. A system comprising:
a processor configured to:
detect language information within a media stream;
analyze the detected language information according to a plurality of linguistic criteria comprising at least one of lexical density, semantic complexity, syntactic structure, or emotional valence;
determine a rendering context associated with a user based on the analyzed language information and one or more user consumption patterns;
perform an artificial intelligence (AI)-based contextual analysis of one or more media segments associated with the detected language information;
determine one or more caption parameters based on a synthesis of the linguistic analysis and one or more user interaction patterns associated with the user;
generate one or more caption data structures based on the determined caption parameters; and
output the generated caption data structures through a rendering pipeline for synchronous integration with the media stream.

17. The system of claim 16, wherein the processor is further configured to establish a continuous monitoring protocol for the media stream at a frame buffer level using a non-blocking observer pattern prior to detecting the language information.

18. The system of claim 16, wherein the processor is further configured to capture one or more implicit interaction signals comprising at least one of a pause, a rewind, a forward skip, or a playback speed adjustment, and wherein the rendering context is further determined based on the captured implicit interaction signals.

19. The system of claim 16, wherein the processor is further configured to generate a plurality of parallel caption complexity tracks during a pre-processing phase, each complexity track incorporating linguistic and temporal characteristics optimized for a different user segment, the plurality of caption complexity tracks ranging from simplified vocabulary with extended display durations to dense technical language with accelerated timing parameters.

20. The system of claim 16, wherein the processor is further configured to dynamically adjust the one or more caption parameters based on a temporal weighting function that progressively transitions from historically-derived caption parameters toward real-time behavioral adaptations as interaction data accumulates within a current session.
